(19) United States
(12) Patent Application Publication
(10) Pub. No.: US 2019/0163628 A1
(43) Pub. Date: May 30, 2019

(54) MULTI-LEVEL SYSTEM MEMORY WITH A BATTERY BACKED UP PORTION OF A NON VOLATILE MEMORY LEVEL

(71) Applicant: Intel Corporation, Santa Clara, CA (US)

(72) Inventors: Zhe WANG, Portland, OR (US); Alaa R. ALAMELDEEN, Hillsboro, OR (US)

(21) Appl. No.: 16/262,691

(22) Filed: Jan. 30, 2019

(51) Int. Cl. G06F 12/0804

(52) U.S. Cl. CPC G06F 12/0804; G06F 2212/1032

(57) ABSTRACT

An apparatus is described. The apparatus includes memory control logic circuitry having circuity to a limit an amount of dirty data kept in a volatile level of a multi-level memory. The volatile level of the multi-level memory to act as a cache for a non-volatile, lower level of the multi-level memory. The amount of dirty data in the cache to be limited by the memory control logic circuitry to less than the capacity of the cache.

### FIELD OF INVENTION

The field of invention is directed to the computing sciences, generally, and, more specifically, to a multi-level system memory with a battery backed up portion of a non-volatile memory level.

### BACKGROUND

A pertinent issue in many computer systems is the system memory (also referred to as “main memory”). Here, as is understood in the art, a computing system operates by executing program code stored in system memory and reading/writing data that the program code operates on from/to system memory. As such, system memory is heavily utilized with many program code and data reads as well as many data writes over the course of the computing system's operation. Finding ways to improve system memory accessing performance is therefore a motivation of computing system engineers. The information in main memory is typically the most current and therefore amongst the most important within the computer at the time of its operation. Main memory has traditionally been implemented with volatile DRAM memory thus loss of data in DRAM during a power loss event is also a concern of computer system designers.

### FIGURES

A better understanding of the present invention can be obtained from the following detailed description in conjunction with the following drawings, in which:

FIG. 1 shows a computer system having a multi-level system memory;

FIG. 2 shows a battery back-up technique for multi-level system memory;

FIG. 3 shows memory control intelligence logic circuitry for implementing the technique of FIG. 2;

FIG. 4 shows a computing system.

### DETAILED DESCRIPTION

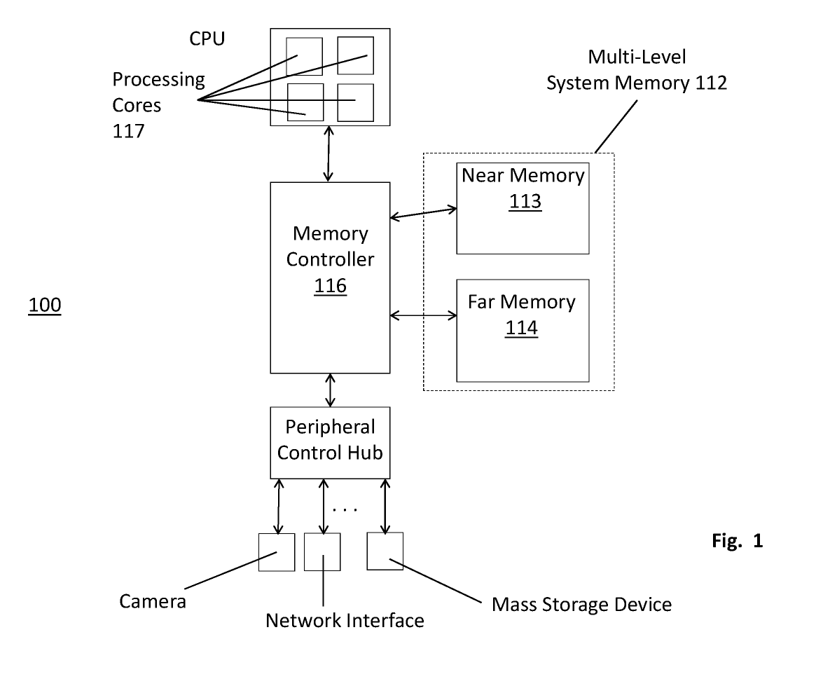

FIG. 1 shows an embodiment of a computing system 100 having a multi-tiered or multi-level system memory 112. According to various embodiments, a smaller, faster near memory 113 may be utilized as a cache for a larger, slower far memory 114. In various embodiments, near memory 113 is used to store the more frequently accessed items of program code and/or data that are kept in system memory 112. By storing the more frequently used items in near memory 113, the system memory 112 will be observed as faster because the system will often read/write from/to items that are being stored in faster near memory 113.

According to various embodiments, near memory 113 has lower access times than the lower tiered far memory 114 For example, the near memory 113 may exhibit reduced access times by having a faster clock speed than the far memory 114. Here, the near memory 113 may be a faster (e.g., lower access time or higher bandwidth), volatile system memory technology (e.g., high performance dynamic random access memory (DRAM) and/or SRAM memory cells) co-located with the memory controller 116. By contrast, far memory 114 may be either a volatile memory technology implemented with a slower clock speed (e.g., a DRAM component that receives a slower clock or lower bandwidth) or, e.g., a non-volatile memory technology that is slower (e.g., longer access time) than volatile/DRAM memory or whatever technology is used for near memory.

In the case of the later, far memory 114 may be comprised of an emerging non-volatile random access memory technology such as, to name a few possibilities, a phase change based memory, a three dimensional crosspoint memory having non-volatile storage cells, “write-in-place” non-volatile main memory devices, memory devices having storage cells composed of chalcogenide, multiple level flash memory, multi-threshold level flash memory, a ferro-electric based memory (e.g., FRAM), a magnetic based memory (e.g., MRAM), a spin transfer torque based memory (e.g., STT-RAM), a resistor based memory (e.g., ReRAM), a Memristor based memory, universal memory, Ge2Sb2Te5 memory, programmable metallization cell memory, amorphous cell memory, Ovshinsky memory, etc. Any of these technologies may be byte addressable so as to be implemented as a system memory in a computing system (also referred to as a “main memory”) rather than traditional block or sector based non-volatile mass storage.

Emerging non-volatile random access memory technologies typically have some combination of the following: 1) higher storage densities than DRAM (e.g., by being constructed in three-dimensional (3D) circuit structures (e.g., a crosspoint 3D circuit structure integrated in the metal wiring above the substrate of a semiconductor chip)); 2) lower power consumption densities than DRAM at least while idling (e.g., because they do not need refreshing); and/or, 3) access latency that is slower than DRAM yet still faster than traditional non-volatile memory technologies such as FLASH. The latter characteristic in particular permits various emerging non-volatile memory technologies to be used in a main system memory role rather than a traditional mass storage role (which is the traditional architectural location of non-volatile storage).

Regardless of whether far memory 114 is composed of a volatile or non-volatile memory technology, in various embodiments far memory 114 acts as a true system memory in that it supports finer grained data accesses (e.g., cache lines) rather than only larger based “block” or “sector” accesses associated with traditional, non-volatile mass storage (e.g., solid state drive (SSD), hard disk drive (HDD)), and/or, otherwise acts as a byte addressable memory that the program code being executed by processor(s) of the CPU operate out of.

In various embodiments, system memory may be implemented with dual in-line memory modules (DIMMs) where a single DIMM has both volatile (e.g., DRAM) and (e.g., emerging) non-volatile memory semiconductor chips disposed on it. In other configurations DIMMs having only DRAM chips may be plugged into a same system memory channel (e.g., a double data rate (DDR) channel) with DIMMs having only non-volatile system memory chips.

In another possible configuration, a memory device such as a DRAM device functioning as near memory 113 may be assembled together with the memory controller 116 and processing cores 117 onto a single semiconductor device (e.g., as embedded DRAM) or within a same semiconductor package (e.g., stacked on a system-on-chip that contains, e.g., the CPU, memory controller, peripheral control hub, etc.). Far memory 114 may be formed by other devices, such as slower DRAM or emerging non-volatile memory and may be attached to, or integrated in the same package as well. Alternatively, far memory may be external to a package that contains the CPU cores. A far memory controller may also exist between the host side main memory controller and far memory devices. The far memory controller may be integrated within a same semiconductor chip package as CPU cores and the host side main memory controller, or, may be located outside such a package (e.g., by being integrated on a DIMM having far memory devices).

In various embodiments, at least some portion of near memory 113 has its own system address space apart from the system addresses that have been assigned to far memory 114 locations. In this case, the portion of near memory 113 that has been allocated its own system memory address space acts, e.g., as a higher priority level of system memory (because it is faster than far memory). In further embodiments, some other portion of near memory 113 (or all of near memory) may also act as a memory side cache (that caches the most frequently accessed items from main memory (which may service more than just the CPU core(s) such as a GPU, peripheral, network interface, etc.) or last level CPU cache (which only services CPU core(s)).

An issue with multi-level system memories having a volatile memory level and a lower non-volatile memory level is the presence of updated (“dirty”) cache lines in near memory upon a power failure event. Here, for instance, referring to a 2LM system having a near memory level composed of volatile DRAM that acts as a memory side cache for a far memory level composed of a non-volatile memory, upon the occurrence of a power failure, the data of any dirty cache lines in the near memory can be lost if adequate precautions are not taken. That is, recalling that more frequently accessed cache lines are generally present in near memory, if any such cache lines contain newly written data that is not written back to non-volatile memory prior to the power failure, such newly written data can be lost in the event of a power failure absent any design feature to protect against the data loss.

According to one approach, the near memory is designed to include a battery backed-up DRAM. In this case, the power supply of the DRAM memory is coupled to a battery which keeps the DRAM memory powered up after a power failure event. Ideally, the battery has an amount of stored charge that is sufficient to supply the DRAM with power for a long enough time period to read the DRAM and write the DRAM contents back to non-volatile far memory. So doing preserves the DRAM data as part of the power loss event shut down procedure.

A problem however is that the size and cost of the battery resources increases as the memory capacity of the near memory increases. For instance, if the storage capacity of the DRAM near memory is tens of gigabytes (or more), a large amount of time is needed to “dump” the near memory contents into far memory during the power loss shut down procedure. The large amount of time, in turn, corresponds to a prohibitively expensive and/or large battery having a very large stored charge capacity.

A solution is to: 1) limit the storage capacity of the battery resources to reduce the expense/size of the battery solution; 2) incorporate a shutdown procedure that (correspondingly) is designed to only save a portion of the near memory; and, 3) during system runtime, force a write through write policy once the amount of dirty information in the near memory has reached the aforementioned portion. Such an approach, in various embodiments, also includes embedded intelligence associated with the near memory that keeps track, in some way, of the amount of dirty data that is being held in the near memory during normal run time of the system.

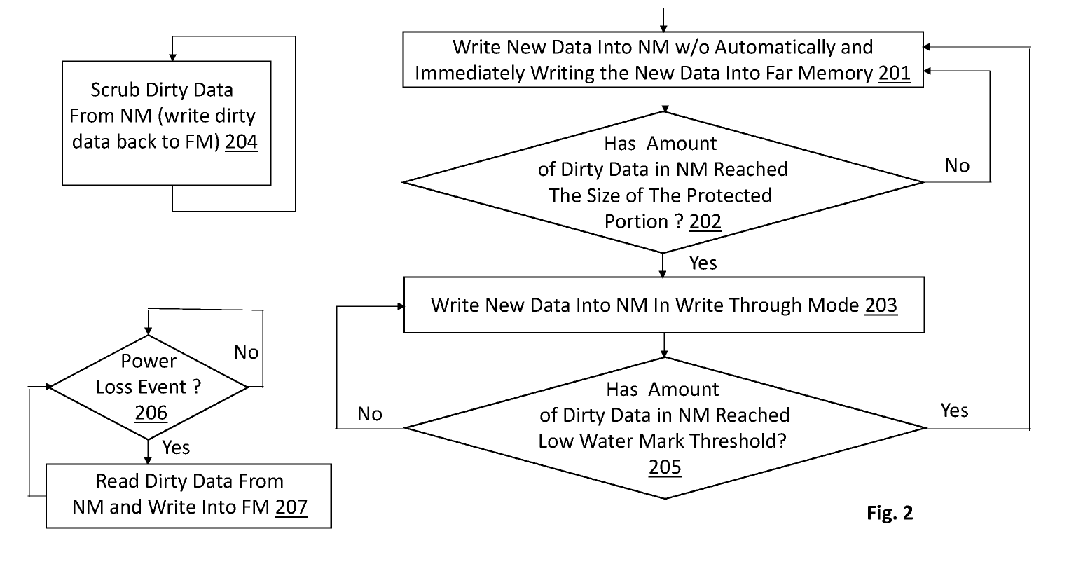

FIG. 2 shows a methodology of such a system. As observed in FIG. 2, initially, new data is written into near memory without any automatic and immediate writing of the same data into deeper non-volatile far memory in order to protect the newly written data 201. For example, according to one approach, new data is written into near memory according to a write back policy (or write back mode) in which new data that is written into near memory is written back to far memory only in a delayed fashion (e.g., when it is replaced by new data in near memory, written back opportunistically and/or some follow-on schedule). Regardless, the new data is not automatically and immediately written back to the far memory 201 as part of the write of the new data into the near memory.

Because new data is not automatically and immediately written back to non-volatile memory as part of the process of writing the data into near memory, the data is otherwise exposed to loss but for the existence of battery back-up. However, in the case of the system described by FIG. 2, battery back-up exists for a smaller “protected portion” of data in near memory which is less than the full storage capacity of near memory.

So long as the amount of dirty data in near memory remains at or less than the size of the protected portion 202, the system is free to write to near memory in a write-back mode or some other unprotected mode 201.

However, when the amount of dirty data within near memory reaches the capacity of the protected portion 202, the near memory access policy switches over to a write through policy. Alternatively, when the amount of dirty data within near memory is close to the capacity of the protected portion and reach a high water mark, the near memory access policy can switch over to a write-through policy. In write through mode data is automatically and immediately written into far memory as part of the overall process of writing the data into near memory 203. Once write through mode operation begins dirty data is no longer written into near memory (all new data written into near memory is immediately copied into far memory and therefore is clean as written). Correspondingly, when in write through mode, all newly written data is also protected against a power loss event (if power is lost after such data is written into near memory, a copy of it already exists in far memory).

As such, going forward in write through mode the amount of dirty data in the near memory does not increase. Additionally, a background scrubbing process is continually executed 204 that seeks out dirty data in near memory and writes it back to far memory. So doing transforms the data from being dirty to being clean and therefore acts to reduce the amount of dirty data in the near memory. The background process 204 may execute continually irrespective of whether the system is operating in unprotected mode 201 or write through mode 203, or, execution of the background process 204 may be triggered by entry of the system into write through mode 203.

Continued execution of the background process 204 while the system is in write through mode causes 203 the amount of dirty data to recede (dirty data cannot be added to near memory and is only reduced in near memory). Eventually, the amount of dirty data in near memory falls to some lower threshold 205 (“low water mark”) and the system re-enters write back mode 202.

In the case of a power loss event 206, whether the system is in write back mode or write through mode, the dirty data in near memory (which, again, remains within the size of the protected portion) is written back 207 to far memory during a battery powered shut down procedure.

Here, with only a portion of the near memory's total memory capacity being battery back-up protected, the amount of battery resources devoted to battery back-up of the near memory can likewise be scaled down for a more cost and/or space effective implementation. Further still, in various embodiments, the hardware architecture supports a battery backed up portion of near memory that is configurable. By architecting a configurable battery backed-up portion, systems manufacturers and/or customers of systems manufacturers (e.g., end-users) can determine, in a customized fashion, the balance of battery capacity vs. cost/size that is appropriate for their particular system and/or application.

For instance, as just one possible example, near memory and far memory is implemented as dual in-line memory modules (DIMMs) that plug-into the system motherboard. According to one approach, DIMMs include both volatile DRAM and non-volatile far memory chips. The volatile DRAM can be reserved as near memory only for the non-volatile memory on its own DIMM, or, the volatile DRAM of a DIMM can be used as near memory for non-volatile memory on its own DIMM and/or non-volatile memory of some other DIMM (e.g., that is plugged into the same memory channel as the DIMM).

Here, some DIMMs having non-volatile DRAM include a battery to support battery back-up of the DIMM's data while other DIMMs having non-volatile DRAM do not contain any such battery. Manufacturers and/or users are therefore free to configure different portions of battery backed near memory by plugging different ratios of battery backed to non battery backed DIMMs in their respective systems.

In embodiments where battery backed-up near memory DRAM on a DIMM is reserved to act only as near memory for non-volatile memory that exists on the same DIMM, the battery backup process is straightforward in that the per DIMM battery capacity need only support the “dumping” of DRAM content from a DIMM into the non-volatile memory of the same DIMM during a power loss event. In this case, for instance, a single system may exist having different kinds of DIMMs including: 1) DIMMs having volatile DRAM and non-volatile memory and on-board battery resources for battery back-up protection; 2) DIMMs having volatile DRAM and non-volatile memory but no on-board battery resources; 3) DIMMs having only DRAM that acts as near memory for the non-volatile memory of other DIMM(s); 4) DIMMs having only non-volatile memory. The DIMMs may be coupled to at least one memory channel such as a dual data rate (DDR) memory channel that conforms to an industry standard specification (e.g., a Joint Electron Device Engineering Council (JEDEC) specification).

Here, the DRAM memory of the DIMMs of only type 1 above are capable of providing the protected portion of near memory, whereas, all other types of DRAM in the system corresponds to the unprotected portion of near memory. In an embodiment, when writing to the DRAM memory space of near memory that is hard configured as unprotected (e.g., DIMM types 2) and 3) above), a write through policy is always used, or, loss of data in unprotected DRAM during a power loss is tolerated. Note that when DRAM on a DIMM can only be used as near memory space for non-volatile memory on the same DIMM, write through is not overly complicated in that a write to near memory also includes a concurrent write of the same data to non-volatile memory on the same DIMM.

According to another or combined approach, the battery storage capacity of a DIMM of type 1 above may not be sufficient to write the entire contents of the DIMM's own DRAM into its own non-volatile memory. That is, only a portion of the DRAM near memory space of a single DIMM is battery back-up protected. In this case, for instance, a smaller protected amount of DRAM space on the DIMM corresponds to a smaller battery on the DIMM and a cheaper and/or smaller DIMM (having less data to be protected, the DIMM can operate for less time after a power failure and save the (limited amount) of data to be protected). Here, the DIMM may include logic circuitry to execute the methodologies of FIG. 2 so that there is a soft delineation of protected vs. unprotected DRAM space on the DIMM. That is, all DRAM space on the DIMM is eligible for battery protection but the DRAM includes logic to limit how much dirty data is stored in the DIMM's DRAM so that the time spent saving it in response to a power loss event is less than if the entirety of the DRAM space were to be saved.

In other embodiments where the DRAM on a DIMM can only be used as near memory space for non-volatile memory on the same DIMM, battery back-up power is supplied from the motherboard rather than the DIMMs. In this case, DIMMs of type 1 above may not exist at all in the system and some DIMMs of type 2 above may have battery backup whereas other DIMMs of type 2 above may not have battery backup. Again, when writing to hard configured unprotected DRAM memory space of near memory (e.g., DIMM of type 2) that is not recognized as having any battery backup, and/or type 3) above), a write through policy is always used, or, loss of data in unprotected DRAM during a power loss is tolerated.

For DIMMs of type 2) that are recognized as having battery backup protection, the entirety of the DIMM's DRAM space may be backed up during a power loss event, or, only a portion of the DIMM's DRAM space is backed up. As discussed at length just above, in the case of the later, the DIMM may include intelligence to limit the amount of dirty data that exists in the DRAM space and only save the limited amount of dirty data in the case of a power loss event.

In either approach (DIMM with on-board battery or motherboard supplied battery backup), note that the system manufacturer and/or system-user is free to configure different amounts of near memory that are protected. As such, configurable amounts of protected near memory space are realizable. Correspondingly, more battery back-up storage capacity or less battery back-up storage capacity (and various granularities in between) can, e.g., be interchangeably fitted (e.g., plugged) into a system allowing for, again, customized per system and/or per user configuration of the portion of near memory that is battery backed-up and the cost and/or real estate devoted to such back-up support.

In embodiments where battery backed-up near memory DRAM on a DIMM can be used as near memory for non-volatile memory that exists on other DIMMs, the power rails of multiple memory modules are battery backed up by battery resources that are integrated into the motherboard, and/or, batteries exist on DIMMs having battery backed-up DRAM space and DIMMs having non-volatile memory that could receive dirty data during the battery backup process. The host side memory controller may also need battery backed operation or some other mechanism to keep the host memory controller operable after a power loss event so that dirty data from the DRAM of one DIMM can be written to the non-volatile memory of another DIMM.

That is, the battery back-up procedure may include the host side memory controller recognizing which data in DRAM space (e.g., of one or more DIMMs) is dirty, reading such dirty from the DRAM space and writing it into the non-volatile memory of another battery backed up DIMM. The host side memory controller may also include intelligence to execute the methodologies of FIG. 2 to limit the amount of data that is dirty within the near memory DRAM across multiple DIMMs generally, and/or the near memory DRAM of DIMMs individually. That is, the host side memory controller may execute the methodologies of FIG. 2 where the near memory corresponds to the combined DRAM space across multiple DIMMs, and/or, the memory controller may execute a separate instance of the methodologies of FIG. 2 for each of the DIMMs it is coupled to having a portion of its near memory DRAM space capable of being battery backed-up.

Alternatively or in combination, logic on one or more battery backed up DIMMs may partially or wholly control the battery backup procedure (in which case the host side memory controller need not be operable after the power loss event). For example, logic circuitry on a DIMM having battery backed near memory DRAM may include intelligence to recognize dirty data in its DRAM memory space and control or otherwise cause such data to be written into the non-volatile memory of another DIMM (e.g., by taking control of a memory channel that both DIMMs are coupled to). The amount of DRAM space on the DIMM that is protected may be all of the DRAM space or just a portion of the DRAM space. In the case of the later, the host side memory controller may have ensured that only a portion of the DRAM space contains dirty data.

Note that although the discussion above was directed to DIMMs specifically, other types of memory modules may be used (e.g., stacked memory modules having ball-grid arrays on their bottom side).

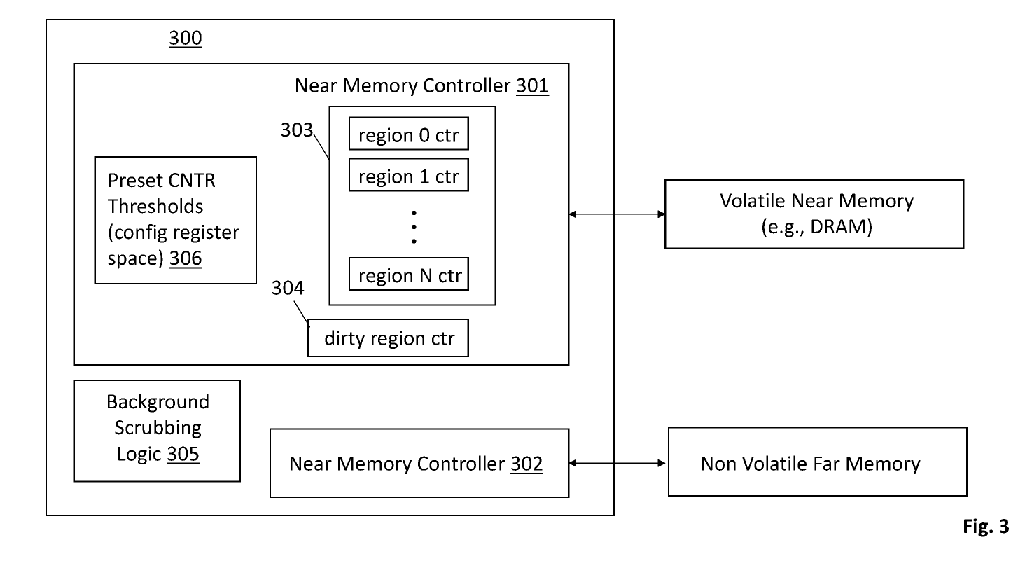

FIG. 3 shows a high level view of memory intelligence logic circuitry 300 suitable for integration on memory control logic circuitry that is disposed on a memory module or a host side memory controller (or distributed on both) to effect the methodologies of FIG. 2. The near memory controller 301 controls near memory DRAM accesses and the far memory controller 302 controls far memory accesses. In various implementations, the near memory controller 301 controls the caching activity described above with respect to FIG. 1.

That is, in the case of a write, if there is a cache hit in near memory the new data is directly written over the older version in near memory. The overwritten cache line is given a dirty state when in write back mode or a clean state when in write through mode. By contrast, in the case of a cache miss, the targeted data (e.g., a targeted cache line) is called up from far memory, overwritten with the new data and written into near memory. The writing of the overwritten cache line from far memory into near memory may cause an existing cache line in near memory to be evicted to far memory to make room for the newly written cache line. The newly written cache line enters the near memory as a dirty cache line in write back mode or a clean cache line in write through mode (in the case of the later, the updated cache line is immediately written back to far memory).

Likewise, in the case of a read, a hit in near memory cache results in the read request being serviced directly from the cache line read from near memory. By contrast, in the case of a miss in near memory cache, the targeted cache line is read from far memory and then written into near memory. The newly entered cache line enters near memory as a clean cache line in both write back and write through modes and may cause a cache line that is present in near memory to be evicted to far memory to make room for the newly entered cache line.

In the scenarios described above, note that cache lines may enter near memory as clean or dirty (depending on the scenario and the write back/through mode). Likewise, clean or dirty cache lines may be evicted from near memory. Keeping track of the amount of dirty data in near memory therefore should include logic circuity that monitors the writing and eviction activity to/from the near memory.

As observed in FIG. 3, the near memory controller includes counters 303 for different regions of the near memory. Each of these counters includes a count of the dirty cache lines in its respective region. In an embodiment, each region corresponds to a different contiguous range of physical address space in near memory (e.g., separate address space chunks of a DIMM's DRAM space, the DRAM space coupled to a memory channel, etc.). Logic circuity (not shown) is instantiated for each counter/region. The logic circuitry increments its region's counter each time a dirty cache line is entered into its region and decrements its region's counter each time a dirty cache line is evicted from its cache line.

Different embodiments can embrace different degrees of granularity regarding the formal tracking of how much near memory data is dirty.

According to one dirty data tracking embodiment, the set of counters 303 are coupled to an adder which adds the counter's respective values to determine the precise number of cache lines that are dirty at any given time. Once the count of dirty cache lines reaches a preset threshold that corresponds to the amount of protected space in near memory, the intelligence logic 300 switched over from write-back mode to write-through mode. After the switch-over to write through mode, as discussed above with respect to FIG. 2, the total count of dirty cache lines will decline owing to the background scrubbing process (performed by background scrubbing logic 305) and the subsequent entry of only clean cache lines into near memory once write through mode is entered. Once the count of dirty cache lines falls below some lower threshold level than the level that tripped the system into write through mode, the system switches back to write back mode. That is, some hysteresis is built into the switching mechanism between modes.

According to a less granular tracking embodiment, an entire region is considered dirty if just one dirty cache line in the region is dirty (i.e., the entire region is considered dirty if the region's count is greater than 1). In this case, a separate dirty region counter 304 is used to count how many regions contain at least one dirty cache line. lithe dirty region counter 304 reaches a pre-determined value the system switches over from write-back mode to write-through mode. Again, some hysteresis may be built into the switching mechanism such that a lesser pre-determined value is used to trigger operation back into write back mode once the write through mode has been entered.

Note that the pre-determined values can be kept in configurable register space 306 that is exposed, e.g., to device driver and/or operating system software so that different system mode triggering levels can be set, e.g., as a function of the size of the protected portion of near memory and/or the amount of battery capacity that has been configured into the system to provide battery back-up support.

In an embodiment, if a region's counter value is zero during a power loss event, the memory intelligence logic 300 does not make any attempt to write back any of the corresponding region's data during the shutdown procedure (there is no need to as all of its data is clean). By contrast, if a counter's value is non-zero, the memory intelligence logic 300 applies a write back protection process to the corresponding region.

With respect to the write-back procedure itself, a region having one or more dirty cache lines is analyzed or processed in some way by the memory intelligence 300 such that dirty cache lines are identified separately from clean cache lines and only dirty cache lines are written back to far memory. Here, according to a first approach, the near memory controller 301 may include a meta data table circuit (not shown) that includes an entry for each cache slot in the near memory and whose meta-data identifies whether the cache line held in the slot is dirty or not. In this case, the memory intelligence 300 scans the entries in the table for each region having a dirty cache line, reads those cache lines identified in the table as dirty and writes these cache lines back to far memory (clean cache lines are not read from near memory).

In another embodiment, whether a cache line is dirty or not is kept in meta-data that is attached to the cache line itself in near memory. In this case, the near memory controller sequentially reads each cache line in a region recognized as having at least one dirty cache line, processes the cache line's attached meta data to recognize whether or not the cache line is dirty, and, writes the cache line back to far memory if it is dirty.

Note that the different battery protection write back schemes can affect the amount of battery power needed to ensure that the protected portion of near memory is properly backed up during a power loss event. In the case of the first approach described above in which the near memory controller looks to an internal table to understand whether a cache line is dirty, the capacity of the battery should correspond to the number of cache lines that “fill” the protected amount of near memory multiplied by the amount of time needed to identify whether a cache line is dirty, read a cache line and write a cache line to far memory.

By contrast in the case of the second approach described above in which the near memory controller has to read each cache line in a region to recognize whether a cache line is dirty or not, the capacity of the battery should correspond to the number of regions times the number of cache lines per region times the amount of time consumed reading a cache line from near memory plus the amount of time needed to write a number of cache lines that correspond to the protected amount of near memory space to far memory.

In various embodiments, the number or regions used to determine the battery capacity corresponds to the regions of near memory that actually have battery backup support. Such regions are also the regions that have tracking counters allocated to them. The regions that have battery backup support can be all regions in near memory (e.g., all physical locations in near memory can be battery backed-up) or less than all regions in near memory (e.g., in the case where some DIMMs have battery back-up and other DIMMs do not have battery backup). As discussed above, in systems where regions of near memory exist that do not have battery backup support, such regions may be permanently written to in write through mode to ensure all data written to such regions survives a power down event even though the regions do not have battery backup, or, loss of their data is tolerated.

The logic circuitry of the intelligence circuit 300 may be logic circuitry that is designed to execute some form of program code (e.g., embedded processor, embedded controller, etc.), dedicated hardwired logic circuitry (e.g., application specific integrated circuit (ASIC) circuitry), programmable logic circuitry (e.g., field programmable logic circuitry (FPGA), programmable logic device (PLD)) or any combination or logic circuitry that executes program code, dedicated hardwired logic circuitry or programmable logic circuitry.

Although embodiments described above have discussed the units of data that are stored in near and far memory as cache lines (e.g., having the same dimension as cache lines kept in CPU caches), in other embodiments other units of data may be used (e.g., super cache lines (each composed of multiple CPU cache lines, pages, blocks of more than one page, etc.).

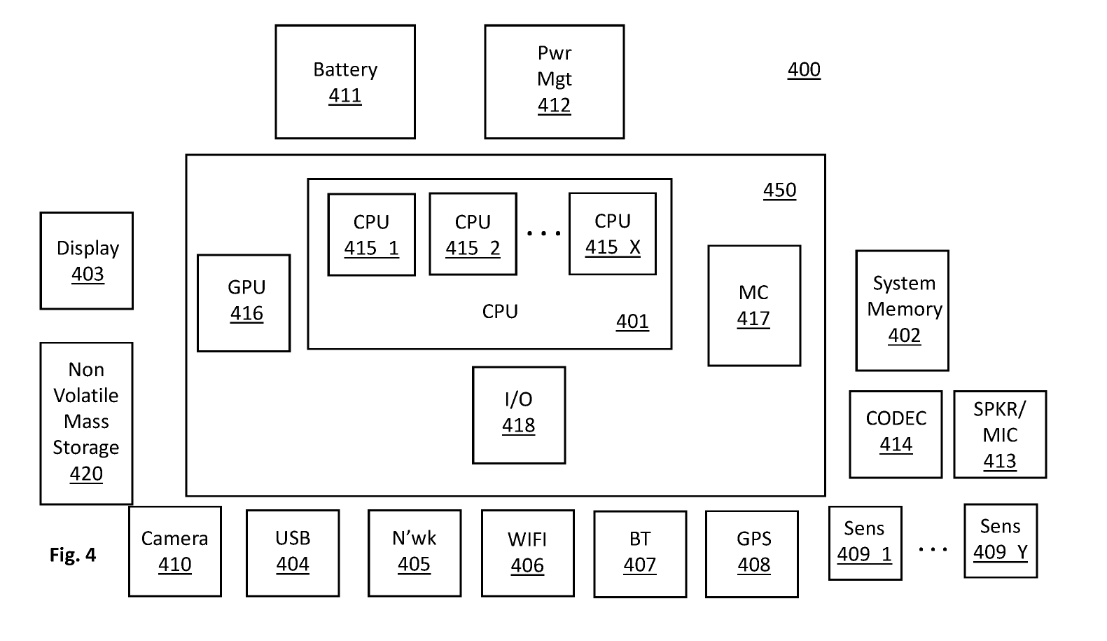

FIG. 4 provides an exemplary depiction of a computing system 400 (e.g., a smartphone, a tablet computer, a laptop computer, a desktop computer, a server computer, etc.). As observed in FIG. 4, the basic computing system 400 may include a central processing unit 401 (which may include, e.g., a plurality of general purpose processing cores 415_1 through 415_X) and a main memory controller 417 disposed on a multi-core processor or applications processor, system memory 402, a display 403 (e.g., touchscreen, flat-panel), a local wired point-to-point link (e.g., USB) interface 404, various network I/O functions 405 (such as an Ethernet interface and/or cellular modem subsystem), a wireless local area network (e.g., WiFi) interface 406, a wireless point-to-point link (e.g., Bluetooth) interface 407 and a Global Positioning System interface 408, various sensors 409_1 through 409_Y, one or more cameras 410, a battery 411, a power management control unit 412, a speaker and microphone 413 and an audio coder/decoder 414.

An applications processor or multi-core processor 450 may include one or more general purpose processing cores 415 within its CPU 401, one or more graphical processing units 416, a memory management function 417 (e.g., a host side memory controller) and an I/O control function 418. The general purpose processing cores 415 typically execute the system and application software of the computing system. The graphics processing unit 416 typically executes graphics intensive functions to, e.g., generate graphics information that is presented on the display 403. The I/O control function may include a peripheral control hub or other circuit having an interface to a mass non-volatile storage 420 (e.g., an interface to a solid state drive (SSD), an interface to a disk drive, etc.).

The memory control function 417 interfaces with the system memory 402 to write/read data to/from system memory 402. The system memory may be implemented as a multi-level system memory. The memory controller function may include intelligence that limits the amount of dirty data in a higher, volatile level of memory to allow for cost-effective and/or configurable battery powered back-up of the volatile level in case of a power loss event as discussed at length above.

Each of the touchscreen display 403, the communication interfaces 404-407, the GPS interface 408, the sensors 409, the camera(s) 410, and the speaker/microphone codec 413, 414 all can be viewed as various forms of I/O (input and/or output) relative to the overall computing system including, where appropriate, an integrated peripheral device as well (e.g., the one or more cameras 410). Depending on implementation, various ones of these I/O components may be integrated on the applications processor/multi-core processor 450 or may be located off the die or outside the package of the applications processor/multi-core processor 450. The power management control unit 412 generally controls the power consumption of the system 400.

Embodiments of the invention may include various processes as set forth above. The processes may be embodied in machine-executable instructions. The instructions can be used to cause a general-purpose or special-purpose processor to perform certain processes. Alternatively, these processes may be performed by specific/custom hardware components that contain hardwired logic circuitry or programmable logic circuitry (e.g., FPGA, PLD) for performing the processes, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, FLASH memory, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. An apparatus, comprising:
memory control logic circuitry comprising circuity to a limit an amount of dirty data kept in a volatile level of a multi-level memory, the volatile level of the multi-level memory to act as a cache for a non-volatile, lower level of the multi-level memory, the amount of dirty data in the cache to be limited by the memory control logic circuitry to less than the capacity of the cache.

2. The apparatus of claim 1 wherein the memory control logic circuitry is disposed on a host side memory controller.

3. The apparatus of claim 1 wherein the memory control logic circuitry further comprises counters to count respective amounts of dirty data in different regions of the volatile level of the multi-level memory.

4. The apparatus of claim 3 wherein the amounts of dirty data are counted in units of cache lines.

5. The apparatus of claim 3 wherein the memory control logic further comprises a counter to count a number of regions that have at least one unit of dirty data.

6. The apparatus of claim 1 wherein the memory control logic circuitry is to begin writing data into the volatile level of the memory according to a write through scheme that copies the write data into the lower, non-volatile level when the amount of dirty data in the volatile level reaches a preset threshold value.

7. The apparatus of claim 6 wherein the memory control logic circuitry comprises a configuration register to store the threshold value.

8. The apparatus of claim 6 wherein the memory control logic is to write data into the volatile level of the memory according to a write back mode when the amount of dirty data in the volatile level is less than a second preset threshold value hat is less than the preset threshold value.

9. A computer system, comprising:
a plurality of processing cores;
a multi-level memory comprising a volatile level and a lower, non-volatile level, the volatile level of the multi-level memory to act as a cache for a non-volatile, lower level of the multi-level memory;
memory control logic circuitry coupled to the multi-level memory, the memory control logic circuitry to limit an amount of dirty data kept in the volatile level of the multi-level memory to less than the capacity of the cache; and,
a solid state drive interface.

10. The computer system of claim 9 wherein the memory control logic circuitry further comprises counters to count respective amounts of dirty data in different regions of the volatile level of the multi-level memory.

11. The computer system of claim 10 wherein the amounts of dirty data are counted in units of cache lines.

12. The computer system of claim 10 wherein the memory control logic further comprises a counter to count a number of regions that have at least one unit of dirty data.

13. The computer system of claim 9 wherein the memory control logic circuitry is to begin writing data into the volatile level of the memory according to a write through scheme that copies the write data into the lower, non-volatile level when the amount of dirty data in the volatile level reaches a preset threshold value.

14. The computer system of claim 13 wherein the memory control logic circuitry comprises a configuration register to store the threshold value.

15. The computer system of claim 17 wherein the memory control logic is to write data into the volatile level of the memory according to a write back mode when the amount of dirty data in the volatile level is less than a second preset threshold value that is less than the preset value.

16. An apparatus, comprising:
a memory module to implement a multi-level memory, the memory module comprising volatile memory to implement a volatile level of the multi-level memory and non-volatile memory to implement a non-volatile level of the multi-level memory, the volatile memory to act as a cache for the non-volatile memory, the memory module comprising memory control logic circuitry to limit an amount of dirty data kept in the volatile memory to less than the capacity of the volatile memory.

17. The apparatus of claim 16 wherein the memory module includes a battery, the battery having reduced battery capacity to support write back of the limited amount of dirty data to the non-volatile memory in response to a power loss event.

18. The apparatus of claim 16 wherein the memory control logic circuitry comprises a configuration register to store a value that establishes the limited amount of dirty data.

19. The apparatus of claim 16 wherein the memory module is a DIMM.

20. The apparatus of claim 16 wherein the memory module is a stacked memory module.
